(19) United States
(12) Patent Application Publication
(10) Pub. No.: US 2026/0094423 A1
(43) Pub. Date: Apr. 2, 2026

(54) METHOD FOR DETERMINING CORRECTIVES TO THE STATISTICAL IDENTIFICATION VARIANCES OF A BIOMETRIC IDENTIFICATION SYSTEM

(71) Applicant: IDEMIA PUBLIC SECURITY FRANCE, Courbevoie (FR)

(72) Inventors: Vincent DESPIEGEL, Courbevoie (FR); Christelle Maria France BAUDRY, Courbevoie (FR); Wassim BOUATAY, Courbevoie (FR)

(73) Assignee: IDEMIA PUBLIC SECURITY FRANCE, Courbevoie (FR)

(21) Appl. No.: 19/254,103

(22) Filed: Jun. 30, 2025

(30) Foreign Application Priority Data
Sep. 30, 2024 (FR) FR2410476

(51) Int. Cl. G06V 10/778; G06V 10/40; G06V 10/75; G06V 10/764; G06V 10/776; G06V 10/82; G06V 20/52; G06V 40/16

(52) U.S. Cl. CPC G06V 10/7788; G06V 10/40; G06V 10/764; G06V 10/776; G06V 10/82; G06V 20/52; G06V 40/171; G06V 40/172; G06V 10/751

(57) ABSTRACT

A method is provided for determining correctives to statistical identification variances of a biometric identification system using facial and/or pedestrian recognition. The method includes (a) defining a set of categories, each category having at least one corresponding physical appearance characteristic; (b) extracting, for each individual, at least one physical appearance characteristic from at least one image of the individual; (c) assigning, to each individual, at least one category on the basis of the extracted physical appearance characteristic; (d) distributing, for each category, each individual into two groups according to the failure or success of their identification by the system; and (e) calculating, for each category, a number of individuals to be selected in the group corresponding to the success of the identification such that the relative proportions of individuals in the group corresponding to the failure of the identification are substantially equal between all the criteria relating to said category.

### TECHNICAL FIELD

The present invention relates to a method and a device for determining correctives to the statistical identification variances of a biometric identification system. It also relates to a biometric identification system comprising such a device.

### TECHNICAL BACKGROUND

It is common practice to check the identity of persons using identification protocols based on comparison of some of their biometric features. Taking advantage of these protocols generally requires a prior registration step whereby an individual checks in with an entity with which they share a certain amount of biometric information and information relating to their identity.

Both registration and identification are based on a step of acquiring biometric features of the individual. For this purpose, the individual stands in front of an acquisition device of an acquisition system that acquires therefrom an image of an area of interest in which certain relevant anthropomorphic and/or anthropometric characteristics can be extracted for later biometric analysis by a biometric processing unit. The identification processes are generally automated to allow in particular free-flow identification, without the individual having to stand in front of the acquisition device. Restricted access areas and border control areas are examples of places where free-flow automatic identification systems are implemented.

### SUMMARY OF THE INVENTION

It has been found that the algorithmic methods used in identification protocols can be affected by biases that lead to a number of identification failures. The intervention of a human operator is then necessary to finish, check or complete the identification. These biases stem from incorrect detection or erroneous analysis of biometric information according to certain physical appearance characteristics of the individual. These physical appearance characteristics may be in particular innate physical appearance characteristics, for example physical and/or ethnic physiological characteristics such as age, gender, and skin color, or adventitious physical appearance characteristics, for example added elements, possibly in the form of physical transformations, such as eyeglasses, tattoos, piercings, and clothing worn on or around the head.

The origins of detection or analysis errors are various. They may result from an under-representation of certain groups of individuals in the training datasets of the algorithms, or even from optical effects related to the conditions surrounding the acquisition device of the identification system, such as, for example, inappropriate lighting causing reflections from reflective surfaces such as eyeglass lenses.

A major drawback of these biases is discrimination against certain groups of individuals according to their physical appearance characteristics, in particular their physical and/or ethnic physiological characteristics. This results in unfair treatment of these individuals during identity and/or access checks since they risk undergoing more frequent checking by a human operator.

According to a first aspect of the invention, there is provision for a method, carried out by a data processing device, for determining correctives to the statistical identification variances of a biometric identification system using facial and/or pedestrian recognition, the method taking, as input datum, a set of images comprising at least one image of each individual of a plurality of individuals that has been acquired by said biometric identification system and the set of states of success or failure of identification of each individual by said biometric identification system, said method providing, as output datum, a set of numbers of individuals to be selected in each category of a set of categories that each relate to at least one physical appearance characteristic, said method comprising the following steps:
(a) defining a set of categories, each category having at least one corresponding physical appearance characteristic;
(b) extracting, for each individual of the plurality of individuals, at least one physical appearance characteristic from at least one image of said individual;
(c) assigning, to each individual, at least one category on the basis of at least one criterion relating to the extracted physical appearance characteristic;
(d) distributing, for each category, each individual of the plurality of individuals into two groups according to the failure or success of their identification by the biometric identification system;
(e) calculating, for each category, a number of individuals to be selected in the group corresponding to the success of the identification such that the relative proportions of individuals in the group corresponding to the failure of the identification are substantially equal between all the criteria relating to said category.

In some embodiments, the method further comprises, prior to step a, a step of extracting, from the plurality of individuals, a sample of individuals comprising individuals representative of the physical appearance characteristics to which at least one category corresponds, steps b to e then being applied to said sample of individuals.

In some embodiments, the set of images comprising at least one image of each individual of a plurality of individuals that has been acquired by said biometric identification system and the set of states of success or failure of identification of each individual by said biometric identification system are a sample of the identification history of said biometric identification system over a fixed period of time.

In some embodiments, step b of extracting at least one physical appearance characteristic and step c of assigning at least one category are performed using a previously trained convolutional neural network.

In some embodiments, the physical appearance characteristic is chosen from among innate physical appearance characteristics and/or adventitious physical appearance characteristics.

In a second aspect of the invention, there is provision for a data processing device comprising means for carrying out a method according to the first aspect of the invention.

In a third aspect of the invention, there is provision for a computer program comprising instructions that, when the program is executed by a data processing device, cause the latter to carry out a method according to the first aspect of the invention.

In a fourth aspect of the invention, there is provision for a storage medium that can be read by a data processing device, comprising instructions that, when executed by a data processing device, cause the latter to carry out a method according to the first aspect of the invention.

In a fifth aspect of the invention, there is provision for a biometric identification system comprising a data processing device according to the second aspect of the invention.

In a sixth aspect of the invention, there is provision for a method for correcting the statistical identification variances of a biometric identification system using facial and/or pedestrian recognition, said method comprising the following steps:
(a) determining the correctives to the statistical identification variances of the biometric identification system using a method according to the first aspect of the invention;
(b) selecting, preferably randomly, for each category, individuals in the group corresponding to successful identification;
(c) checking the selected individuals by way of a human officer.

In a seventh aspect of the invention, there is provision for the use of a method according to the first aspect of the invention for correcting the statistical identification variances of a biometric identification system using facial and/or pedestrian recognition in a border control area.

### BRIEF DESCRIPTION OF THE DRAWINGS

FIG. 1 is a schematic representation of an example of a border control area comprising a free-flow biometric identification sub-area.

FIG. 2 is a schematic representation of an example of a biometric identification system.

FIG. 3 is a schematic representation of an example of a biometric processing device.

FIG. 4 is an example of a graphical representation of the frequencies of success and failure of identification, by a biometric identification system, of a plurality of individuals according to multiple categories of physical appearance characteristics.

FIG. 5 is a flowchart of a method according to one embodiment of the invention.

FIG. 6 is a schematic graphical representation of the frequencies of success and failure of identification, by a biometric identification system, of a plurality of individuals according to multiple categories of physical appearance characteristics, prior to correction.

FIG. 7 is a graphical representation of the frequencies of success and failure of identification from FIG. 6 after correction using a method according to the invention.

### DETAILED DESCRIPTION OF EMBODIMENTS

In the present disclosure, embodiments are described in the general context of one or more pieces of hardware or devices capable of executing preloaded instructions such as, for example, computer-executable instructions for executing program modules. The program modules may include one or more routines, programs, objects, variables, commands, scripts, functions, applications, components and/or data structures able to execute particular tasks or implement particular types of abstract data.

Some embodiments may also be implemented in distributed computing environments where tasks are executed by remote data processing devices that are connected by a communication network. In a distributed computing environment, the program modules may reside on local and/or remote computer storage media, including memory storage devices.

Referring to FIG. 1, a border control area 100, such as an airport, is likely to be provided therewith, the travelers 101 generally having the option of choosing between a sub-area 102 with consent to biometric identification and a sub-area 103 without consent to biometric identification in order to access the gates 104 for boarding, when leaving a territory, or arrival, when arriving in the territory.

The sub-area 103 without consent to biometric identification consists of a simple passageway in which the travelers 101 wait before going to a desk 105 where a human officer 106 is responsible for checking their identity. Depending on the national legislation in force, in compliance with the wishes of travelers that their anthropomorphic and/or anthropometric characteristics should not undergo biometric analysis, the sub-area 103 without consent may have no acquisition and/or recording devices that are able to provide prints of these characteristics, or if it is equipped with such devices, these devices are not configured to transmit these prints to a biometric analysis system.

The sub-area 102 with consent to biometric identification is, on the other hand, provided with one or more devices 107, 108 for acquiring and/or recording prints of the anthropomorphic and/or anthropometric characteristics of the travelers 101 in order to carry out analysis thereof. In the example of a control area shown in FIG. 1, the acquisition devices 107, 108 are two aerial monocular cameras arranged on either side of a first room 102a that the travelers 101 are invited to cross. The two cameras 107, 108 are oriented according to a downward angle of view in order to acquire one or more prints of the faces of the travelers 101 who have previously registered, for example during a previous check-in step. The prints are then transmitted to a biometric processing device (not shown) that extracts print biometric templates therefrom and then compares them with the reference biometric templates in a database and identifies the travelers 101 on the basis of this comparison.

Having crossed the first room 102a, the travelers enter a second room 102b, adjoining the first, in which the travelers 101 not identified by the identification system are directed to the control desk 105 by a human control officer 109 for manual identification. At the same time, the correctly identified travelers 101 are allowed to access the boarding or arrival gates 104. The second room 102b may comprise a checking device composed, in the example, of two surveillance cameras 110, 111, arranged on either side of the room, in order to prevent any attempt by an unidentified traveler to access the boarding or arrival gates 104.

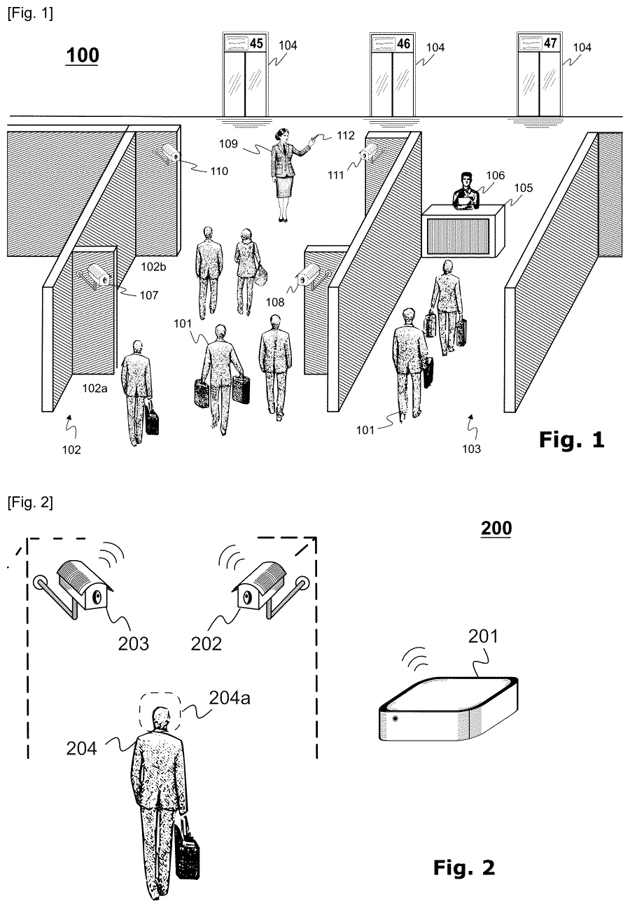

Referring to FIG. 2, a biometric identification system 200 that can be used to carry out free-flow identification in a border control area 100 may be a facial and/or pedestrian recognition system. The system 200 comprises a biometric processing device 201 and one or more videographic and/or photographic recording devices 202, 203, such as one or more monocular cameras. For security reasons, the biometric processing device 201 is located remotely from the videographic and/or photographic recording devices 202, 203, generally in a dedicated room. It communicates with videographic recording devices 202, 203 by way of any suitable wired or electromagnetic telecommunication device.

The recording device or devices 202, 203 are configured to record an image of an area 204a of interest of an individual 204 in which certain relevant anthropomorphic and/or anthropometric characteristics of the individual 204 can be extracted and converted into a print biometric template by the biometric processing device 201. The biometric processing device 201 then compares the print biometric template with one or more reference biometric templates in a database. If there is a match between the print biometric template and at least one reference biometric template associated with an individual identified in the database, the individual 104 is classed as identified by the identification system 200. Otherwise, the individual 104 is not classed as identified. They must then undergo a manual check by a human officer 106.

The area 204a of interest of the individual 204 depends on the type of recognition carried out by the biometric identification system 200. In the case of facial recognition, the area 204a of interest comprises the face and/or one or more characteristic elements of the face, such as the eyes, the oral commissure or commissures or the nose. In the case of pedestrian recognition, the area 204a of interest comprises at least the upper part of the body of the individual 204, or even the whole of their body, and the biometric processing device 201 extracts a biometric template from an analysis of the posture, build and/or gait of the individual 104.

Examples of a system and method for biometric identification using facial recognition are described in; A1 Xinyi, et al. “A survey of face recognition.” arXiv preprint arXiv: 2212.13038 (2022); US 2017/0330028 A1 [Idemia Identity and Security USA LLC] Nov. 16, 2017; EP 3 285 209 A2 [Safran Identity and Security SAS] Feb. 21, 2018.

Examples of a system and method for biometric identification using pedestrian recognition are described in Ye, Mang, et al. “Deep learning for person re-identification: A survey and outlook.” IEEE transactions on pattern analysis and machine intelligence 44.6 (2021): 2872-2893; US 2017/0316255 A1 [Panasonic Intellectual Property Management Co Ltd Wang] Nov. 2, 2017; WO 2019/188111 A1 [NEC CORP] Oct. 3, 2019; US 2015/0193686 [Tata Consultancy Services Ltd] Jul. 9, 2015.

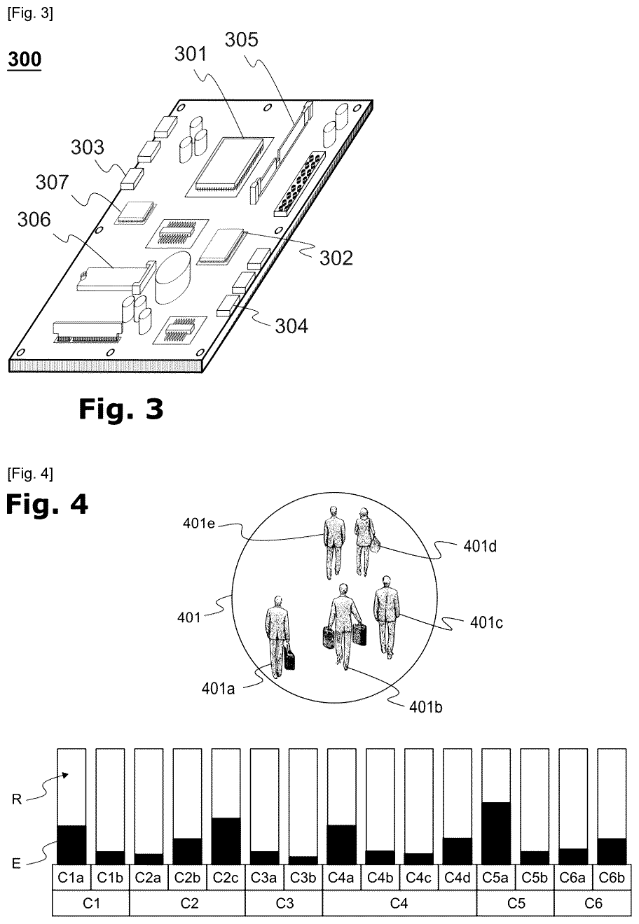

Referring to FIG. 3, a biometric processing device 201 is generally a data processing device 300 comprising means for carrying out a biometric identification method as described above. This device 300 comprises one or more central processing units (CPU) 301 and/or one or more graphics processing units (GPU) 302, a physical remote-communication module 303, one or more physical input/output modules 304 for interchanging data with external devices, a transient storage medium 305 such as a random access memory (RAM), a non-transient storage medium 306, and communication buses (not shown) for transferring data between the internal components of the device 300. It may also comprise a secure element 308 for storing cryptographic keys, executing encryption algorithms, and/or storing and/or encrypting any other algorithm and/or datum whose security and confidentiality must be protected, for example a database of reference biometric templates.

The biometric processing device 203 is used to execute one or more program modules comprising instructions that, when the program module or modules are executed, cause said biometric processing device 203 to carry out a biometric identification method as described above. The program module or modules may be written in any, compiled or interpreted, programming language. They may form part of a software solution, i.e. of a collection of executable instructions, of codes, of scripts or the like and/or of databases.

As explained above, the algorithmic methods used in biometric identification protocols can be affected by biases that lead to a number of identification failures. These biases stem from incorrect detection or erroneous analysis of biometric information according to certain innate and/or adventitious physical appearance characteristics of the individual. This results in discrimination against certain groups of individuals according to their physical appearance characteristics, in particular their physical and/or ethnic physiological characteristics. These groups are then more frequently likely to be treated unfairly during automatic identity checks, a human operator having to intervene to overcome automatic identification failures and to perform the check manually.

Referring to FIG. 4, one or more categories C1-C6 relating to one or more physical appearance characteristics may be assigned to each individual in a group 401 of travelers 401a-d. Each discrete or continuous category corresponds to the application of a criterion relating to a physical appearance characteristic. “Physical appearance characteristic” means any innate or adventitious characteristic of the physical appearance of a group of individuals that is able to be used to distinguish between the individuals in said group on the basis of at least one objective criterion specific to that characteristic. Examples of innate physical appearance characteristics are physical and/or ethnic physiological characteristics of the body such as age, height, gender, skin color, face shape, or eye color or shape. Examples of adventitious physical appearance characteristics are added items, possibly in the form of physical transformations, such as eyeglasses, tattoos, piercings, and clothing worn on or around the head.

In the example of FIG. 4, the first category C1 corresponds to whether C1a or not C1b eyeglasses are worn, the second category C2 comprises three ranges C2a, C2b, C3c of skin tone values, the third category C3 corresponds to whether C3a or not C3b there is a tattoo on the face, the fourth category C4 comprises five ranges C4a, C4b, C4c, C4d, C4e of age values, the fifth category C5 corresponds to whether C5a or not C5b a head covering such as a hat, veil or headscarf is worn, and the sixth category C6 corresponds to the male biological gender C6a and to the female biological gender C6b.

Each category C1-C6 has the corresponding application of a criterion relating to a physical appearance characteristic: the first category C1 has the corresponding criterion regarding whether C1a or not C1b eyeglasses are worn; the second category C2 has the corresponding application of a criterion C2a, C2b, C3c regarding skin tone values; the third category C3 has the corresponding application of a criterion regarding whether C3a or not C3b there is a tattoo on the face; the fourth category C4 comprises the application of a criterion C4a, C4b, C4c C4d, C4e regarding age values; the fifth category C5 has the corresponding application of a criterion regarding whether C5a or not C5b a head covering is worn; and the sixth category C6 has the corresponding application of a criterion regarding male C6a or female C6b biological gender.

It should be noted that, in general, for any category associated with a physical appearance characteristic that can be measured on a continuous scale, it is possible to use a continuous scale of values with a thresholding function instead of discrete sub-categories. For example, for the third C3 and fifth C5 categories, instead of ranges, a continuous threshold-based scale can be used for the skin tone value and the age value, respectively.

Each traveler 401a-e in the group 401 may be assigned one or more categories C1-C6 by applying at least one distinction criterion specific to the physical appearance characteristic associated with each of the categories C1-C6. As an example, assuming that the traveler 401a is a man of about thirty years of age, wearing glasses, with a dark skin tone and no tattoos, the categories C1 [C1a], C2 [C2c], C3 [C3a], C4 [C4c], C5 [C5b], C6 [C6a] are assigned to him. In FIG. 4, the distribution of the travelers 401 in the various categories C1-C6 is shown as a histogram of the absolute proportions of individuals in each category.

When a biometric identification algorithm is affected by biases, it may fail to identify more individuals in one or more categories than others. The individuals can thus be distributed into two groups E, R according to the failure E or success R of their identification by the biometric identification algorithm.

By way of example, because he wears eyeglasses and/or has a dark complexion, the traveler 401a may not be identified by the biometric identification system. He will then have to undergo manual identification by an operator. Any other traveler having the same characteristics may suffer a similar fate. A form of discrimination takes place for these people, as they more frequently undergo manual checking.

Generalizing, FIG. 4 shows, purely as an illustration, relative proportions of failure E (black part of the histogram) and success R (white part of the histogram) of identification for each histogram of proportions of individuals in each category C1-C6. It seems that travelers forming part of categories C1, C2, C4 and C5 according to the respective criteria C1a, C2c, C4a, C5a are not statistically identified more frequently. The behavior of the biometric identification system performing a biased biometric identification algorithm can then be classed as discriminatory with regard to the physical appearance characteristics associated with these categories.

The aim of the present invention is to reduce or even eliminate identification biases that are likely to affect current or future biometric identification algorithms. Another aim is to provide a solution that can be adapted for each situation in which these algorithms are performed in order to reduce the need to replace them in whole or in part.

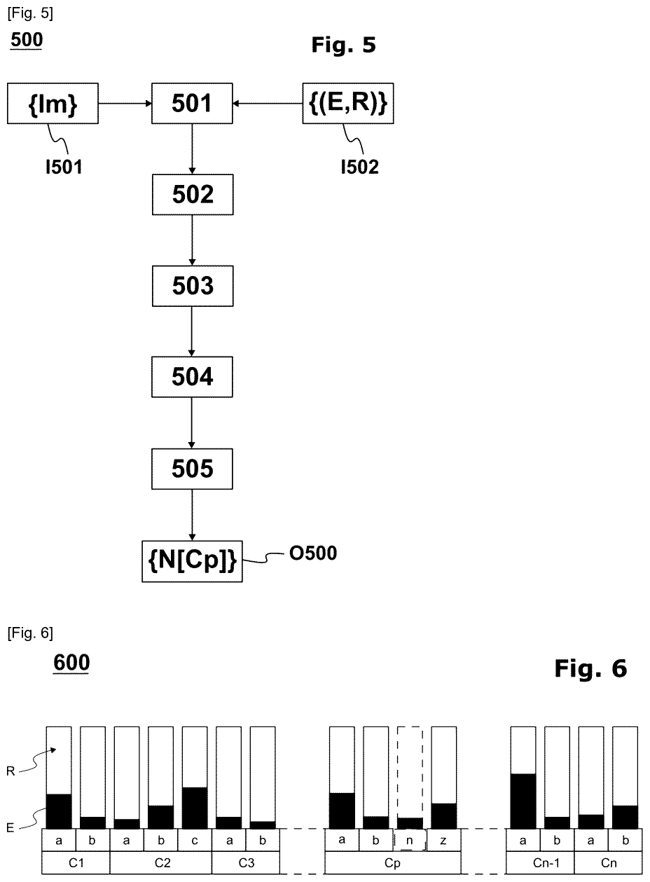

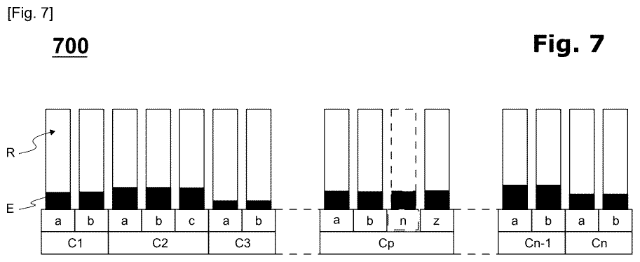

To this end, referring to FIG. 5 & FIG. 6 & FIG. 7, there is provision for a method 500, carried out by a data processing device 300, for determining correctives to the statistical identification variances of a biometric identification system 200 using facial and/or pedestrian recognition, the method 500 taking, as input datum, a set 1501 of images Im comprising at least one image of each individual 101 of a plurality of individuals that has been acquired by said biometric identification system 200 and the set 1502 of states of success R or failure E of identification of each individual 101 by said biometric identification system 200, said method 500 providing, as output datum, a set 0500 of numbers N [Cp] of individuals to be selected in each category Cp of a set of categories C1-Cn that each relate to at least one physical appearance characteristic, said method 500 comprising the following steps:
(a) defining 501 a set of categories C1-Cn, each category having at least one corresponding physical appearance characteristic;
(b) extracting 502, for each individual 101 of the plurality of individuals, at least one physical appearance characteristic from at least one image of said individual 101;
(c) assigning 503/600, to each individual 101, at least one category C1-Cn on the basis of at least one criterion a-z relating to the extracted physical appearance characteristic;
(d) distributing 504/600, for each category Cp, each individual 101 of the plurality of individuals into two groups E, R according to the failure E or success R of their identification by the biometric identification system 200;
(e) calculating 505/700, for each category Cp, a number N [Cp] of individuals to be selected in the group R corresponding to the success R of the identification such that the relative proportions of individuals in the group E corresponding to the failure E of the identification are substantially equal between all the criteria a-z relating to said category Cp.

The method 500 according to the invention provides, for each category Cp, a number N [Cp] of individuals to be checked in the group R corresponding to the success R of the identification. In other words, for each category Cp, a number N [Cp] of individuals correctly identified (group R) by the biometric identification system 200 will be classed as unidentified (group E) and will undergo manual identification by a human officer 106. Thus, during the next identification drive by the biometric identification system 200, for each category Cp, the relative proportions of individuals in the group R will be substantially equal between all the criteria a-z relating to said category Cp, so as, for example, to obtain, for each category Cp, a distribution between the successes R and failures E as shown in the histogram in FIG. 7.

The set 0500 of numbers N [Cp] calculated for each Cp can, for example, be transmitted to the biometric identification system 200, which will then select, preferably randomly, for each category Cp, the N [Cp] individuals in the group R for manual identification by a human officer. Referring to FIG. 1, in the example of a border control area 101, the N [Cp] travelers 101 selected by the identification system 200 are redirected by a control officer 109 to the desk 105, where a human officer 106 is responsible for checking their identity. To that end, the control officer 109 may be equipped with a mobile electronic device 112 on which they are notified of the travelers 101 who need to undergo manual identification, comprising both those selected by the biometric identification system 200 and those that the biometric identification system 200 was unable to identify. Preferably, neither the control officer 109 nor the identification officer 106 is aware of the reason, namely selection or non-identification, for which these travelers 101 are redirected to manual identification.

According to a purely illustrative example of the method according to the invention, a category C1 corresponding to biological gender is defined. Following extraction of the physical appearance characteristics relevant to identification of their gender, each individual 101 of a plurality of individuals is assigned to a category C1 regarding biological gender on the basis of two criteria a, b, corresponding to the female biological gender C1a and the male biological gender C1b, respectively. The distribution of the individuals into two groups according to the failure E or success R of their identification reveals, for example, that 4% of the individuals 101 of the male biological gender C1b are not identified and 2% of the individuals 101 of the female biological gender C1a are not identified. Assuming that the biometric identification system 200 identifies an average of 1000 individuals 101 per day comprising 300 individuals of the male biological gender C1b and 700 individuals of the female biological gender C1a, 12 individuals 101 of the male biological gender C1b and 14 individuals 101 of the female biological gender C1a are therefore not identified. Although the numbers of individuals who are unidentified between the two criteria are very close, the relative proportion of individuals 101 of the male biological gender C1b is twice that of the individuals 101 of the female biological gender C1a.

In order to restore the balance between the relative proportions of identification failure between the individuals of the male biological gender C1b and the individuals of the female biological gender C1a, the calculation step 505/700 is used to determine the number of persons to be selected in the group corresponding to the success R of the identification for each of the two criteria a, b, corresponding to the female biological gender C1a and the male biological gender C1b, respectively. In the example, 39 correctly identified individuals 101 of the female biological gender C1a and 11 correctly identified individuals 101 of the male biological gender C1b will be selected, preferably randomly, when the biometric identification system 200 is next implemented. The relative proportions of individuals 101 who are unidentified, or classed as such, between the two criteria a, b, corresponding to the female biological gender C1a and the male biological gender C1b, respectively, will then be substantially identical. In this case, 7.67% of the individuals 101 of the female biological gender C1a and 7.67% of the individuals 101 of the male biological gender C1b will not be identified or classed as such.

Depending on the type and performance of the biometric identification algorithm performed by the biometric identification system 200, certain physical appearance characteristics can more or less influence the result of the identification of the individuals 101. Identification, by said system 200, of the individuals 101 belonging to the categories relating to these physical appearance characteristics is therefore likely to fail more frequently than that of individuals in the other categories. For example, for the reasons mentioned above, a biometric identification algorithm may fail to identify individuals wearing eyeglasses more than individuals having different physical appearance characteristics. Alternatively, a biometric identification algorithm may have an acceptable identification failure rate for individuals belonging to some categories but not for others.

Also, according to some embodiments, the method further comprises, prior to step 502, a step 502a of extracting, from the plurality of individuals, a sample of individuals comprising individuals representative of the physical appearance characteristics to which at least one category Cp corresponds, steps 502 to 505 then being applied to said sample of individuals. Such sampling allows corrections of statistical identification variances to be concentrated on individuals for whom the biometric identification system 200 is the most defective, while maintaining its performance in identifying other individuals. As the method 500 limits corrections to just a limited number of categories of individuals, it is more efficient in terms of computational resources and therefore energy.

The method 500 according to the invention can be carried out in real time or in a manner delayed with respect to the period of operation of the biometric identification system 200. In some embodiments, the set 1501 of images comprising at least one image of each individual 101 of a plurality of individuals that has been acquired by said biometric identification system 200 and the set 1502 of states of success R or failure E of identification of each individual 101 by said biometric identification system 200 are a sample of the identification history of said biometric identification system 200 over a fixed period of time.

When the method is carried out in real time, the fixed period of time may, for example, be a rolling period regularly updated at a given frequency to reflect the most recent identification operations as the biometric identification system 200 is used. With each update, the method 500 according to the invention redetermines the correctives to be applied to said system 200 and transmits thereto an updated set 0500 of numbers N [Cp] of individuals calculated for each Cp that it will now have to select for manual identification. This update operation takes place at a given frequency, for example daily, throughout the entire period of operation of the biometric identification system 200.

When the method is carried out with a delay, a sample of the identification history of the biometric identification system 200 is supplied, as input datum, to the method 500 according to the invention at the end of an individuals identification drive by said system 500. From this sample, the method 500 according to the invention redetermines the correctives to be applied to said system 200 and transmits thereto an updated set 0500 of numbers N [Cp] of individuals calculated for each Cp. Then, during the next identification drive, the system 200 will apply this update.

In step 502, the extraction, for each individual 101 of the plurality of individuals, of at least one physical appearance characteristic from at least one image of said individual is performed using any suitable method. According to some preferred embodiments, step 502 of extracting at least one physical appearance characteristic and step 503 of assigning at least one category C1-Cn are performed using a previously trained convolutional neural network. Examples of convolutional neural networks suitable for determining a person's gender and age are described in Levi, Gil, and Tal Hassner. “Age and gender classification using convolutional neural networks.” Proceedings of the IEEE conference on computer vision and pattern recognition workshops. 2015; Kuprashevich, Maksim, and Irina Tolstykh. “Mivolo: Multi-input transformer for age and gender estimation.” International Conference on Analysis of Images, Social Networks and Texts. Cham: Springer Nature Switzerland, 2023.

In a second aspect of the invention, referring to FIG. 3, the method 500 according to the invention can be carried out by a data processing device 300.

In a third aspect, the method 500 according to the invention is in the form of a computer program or a computer program module comprising instructions that, when the program is executed by a data processing device 300, carry out said method 500.

In a fourth aspect of the invention, the computer program or the computer program module is stored in a non-transient recording medium 306 of a data processing device 300.

In a fifth aspect of the invention, there is provision for a biometric identification system 200 comprising a data processing device 300 according to the second aspect of the invention. Preferably, the data processing device 300 is constituted by the biometric processing device of said system 200.

The method 500 according to the first aspect of the invention and/or the system 200 according to the fifth aspect of the invention can advantageously be used for correcting the statistical identification variances of a biometric identification system 200 using facial and/or pedestrian recognition in a border control area 100 such as, for example, described in the context of FIG. 1.

To this end, in a sixth aspect of the invention, the method 500 according to the first aspect of the invention can advantageously be used to carry out a method for correcting the statistical identification variances of a biometric identification system 200 using facial and/or pedestrian recognition. Such a correction method comprises the following steps:
(a) determining the correctives to the statistical identification variances of the biometric identification system 200 using a method 500 according to any one of the embodiments of the first aspect of the invention;
(b) selecting, preferably randomly, for each category Cp, N [Cp] individuals in the group R corresponding to successful identification;
(c) checking the selected individuals by way of a human officer.

### REFERENCES

### Patent Literature

US 2015/0193686 [Tata Consultancy Services Ltd] Jul. 9, 2015
US 2017/0316255 A1 [Panasonic Intellectual Property Management Co Ltd Wang] Nov. 2, 2017.
US 2017/0330028 A1 [Idemia Identity and Security USA LLC] Nov. 16, 2017.
EP 3 285 209 A2 [Safran Identity and Security SAS] Feb. 21, 2018 WO 2019/188111 A1 [NEC CORP] Oct. 3, 2019.

### Non-Patent Literature

Levi, Gil, and Tal Hassner. “Age and gender classification using convolutional neural networks.” Proceedings of the IEEE conference on computer vision and pattern recognition workshops. 2015.
Ye, Mang, et al. “Deep learning for person re-identification: A survey and outlook.” IEEE transactions on pattern analysis and machine intelligence 44.6 (2021): 2872-2893.
Wang, Xinyi, et al. “A survey of face recognition.” arXiv preprint arXiv: 2212.13038 (2022).
Kuprashevich, Maksim, and Irina Tolstykh. “Mivolo: Multi-input transformer for age and gender estimation.” International Conference on Analysis of Images, Social Networks and Texts. Cham: Springer Nature Switzerland, 2023.

1. A method, carried out by a data processing device, for determining correctives to the statistical identification variances of a biometric identification system using facial and/or pedestrian recognition, the method taking, as input datum, a set of images comprising at least one image of each individual of a plurality of individuals that has been acquired by said biometric identification system and the set of states of success or failure of identification of each individual by said biometric identification system, said method providing, as output datum, a set of numbers of individuals to be selected in each category of a set of categories that each relate to at least one physical appearance characteristic, said method comprising the following steps:
(a) defining a set of categories, each category having at least one corresponding physical appearance characteristic;
(b) extracting, for each individual of the plurality of individuals, at least one physical appearance characteristic from at least one image of said individual;
(c) assigning, to each individual, at least one category on the basis of at least one criterion relating to the extracted physical appearance characteristic;
(d) distributing, for each category, each individual of the plurality of individuals into two groups according to the failure or success of their identification by the biometric identification system;
(e) calculating, for each category, a number of individuals to be selected in the group corresponding to the success of the identification such that the relative proportions of individuals in the group corresponding to the failure of the identification are substantially equal between all the criteria relating to said category, the number of individuals selected for each category being transmitted to the system, which then selects, for each category, during the next identification drive, the individuals in the group for manual identification by a human officer.

2. The method as claimed in claim 1, wherein the method further comprises, prior to step, a step of extracting, from the plurality of individuals, a sample of individuals comprising individuals representative of the physical appearance characteristics to which at least one category corresponds, steps to then being applied to said sample of individuals.

3. The method as claimed in claim 1, wherein the set of images comprising at least one image of each individual of a plurality of individuals that has been acquired by said biometric identification system and the set of states of success or failure of identification of each individual by said biometric identification system are a sample of the identification history of said biometric identification system over a fixed period of time.

4. The method as claimed in claim 1, wherein step of extracting at least one physical appearance characteristic and step of assigning at least one category are performed using a previously trained convolutional neural network.

5. The method as claimed in claim 1, wherein the physical appearance characteristic is chosen from among innate physical appearance characteristics and/or adventitious physical appearance characteristics.

6. A data processing device comprising means for carrying out a method as claimed in claim 1.

7. A computer program comprising instructions that, when the program is executed by a data processing device, cause the latter to carry out a method as claimed in claim 1.

8. A storage medium that can be read by a data processing device, comprising instructions that, when executed by a data processing device, cause the latter to carry out a method as claimed in claim 1.

9. A biometric identification system comprising a data processing device as claimed in claim 6.

10. A method for correcting the statistical identification variances of a biometric identification system using facial and/or pedestrian recognition, said method comprising the following steps:
(a) determining the correctives to the statistical identification variances of the biometric identification system using a method as claimed in claim 1;
(b) selecting, preferably randomly, for each category, individuals in the group corresponding to successful identification;
(c) checking the selected individuals by way of a human officer.

11. The use of a method as claimed in claim 1 for correcting the statistical identification variances of a biometric identification system using facial and/or pedestrian recognition in a border control area.
